(19) United States
(12) Patent Application Publication
(10) Pub. No.: US 2024/0059161 A1
(43) Pub. Date: Feb. 22, 2024

(54) Expansion Module for a Vehicle, System Comprising an Expansion Module, and Vehicle Comprising a Receiving Area for an Expansion Module

(71) Applicant: Bayerische Motoren Werke Aktiengesellschaft, Muenchen (DE)

(72) Inventors: Uwe FISCHER, Muenchen (DE); Romain LAUVERGNE, Muenchen (DE); Nico RICHTER, Oxford (GB)

(21) Appl. No.: 18/265,772

(22) PCT Filed: Nov. 5, 2021
(86) PCT No.: PCT/EP2021/080774

§ 371 Date: Jun. 7, 2023

(30) Foreign Application Priority Data
Dec. 17, 2020 (DE) 10 2020 134 071.0

(51) Int. Cl. B60L 50/64; B60L 53/80

(52) U.S. Cl. CPC B60L 50/64; B60L 53/80

(57) ABSTRACT

An expansion module for a vehicle includes an onboard electrical system. The onboard electrical system has an electrical energy store and a receiving area for the expansion module. The expansion module includes a module interface and a functional unit. The module interface is configured to form a mechanical connection to a receiving interface of identical design of the receiving area and one or more electrically conductive collections between the expansion module and the receiving area. The functional unit is configured to provide an expansion function for the onboard electrical system of the vehicle, via the one or more electrically conductive connections.

### BACKGROUND

This specification relates to an expansion module for a (high-voltage, h.v.) onboard electrical system of a (motor) vehicle. This specification also relates to a system having an expansion module and to a vehicle having a receiving area for an expansion module.

An at least partially electrically powered vehicle comprises an electrical energy store, which is designed to store electrical energy for the operation of an electric drive machine of the vehicle. The electrical energy store can be charged via a charging interface, particularly via a charging socket of the vehicle at an off-vehicle charging station.

Particularly in densely populated areas, it can be difficult to provide a sufficient number of charging stations for the charging of vehicles. Moreover, the range of an exclusively electrically powered vehicle, on the grounds of the limited capacity of the electrical energy store, is generally relatively restricted.

### SUMMARY

This specification addresses the technical object of providing a flexible charging process for an electrical energy store of a vehicle and/or of increasing the available electrical energy in a vehicle in a flexible manner.

It should be observed that additional features of a patent claim which is dependent upon an independent patent claim, in the absence of the features of the independent patent claim or in combination with only a proportion of the features of the independent patent claim, can constitute a standalone invention which is independent of the combination of all features of the independent patent claim, and which may be the subject matter of an independent claim, a divisional application or a subsequent application. The same applies, correspondingly, to the technical instruction described in the description, which can constitute an invention which is independent of the features of the independent patent claims.

According to one aspect, an expansion module for a (motor) vehicle is described. The vehicle comprises an onboard electrical system (particularly a h.v. onboard system, e.g. having an onboard system voltage of 100 V or higher) having an electrical energy store (e.g. with a lithium-ion battery). The vehicle further comprises a receiving area for the expansion module. The receiving area can comprise e.g. a shaft for the accommodation of the expansion module. The expansion module can assume e.g. a cuboid shape, and the receiving area can comprise a void which corresponds to the cuboid shape of the expansion module. The receiving area can be arranged e.g. in an engine compartment and/or in a trunk space of the vehicle.

The expansion module comprises a module interface, which is configured to form a mechanical connection to a receiving interface of identical design (the receiving area of the vehicle) and one or more electrically conductive collections between the expansion module (or the module interface) and the receiving area (or the receiving interface). In other words, the expansion module comprises a module interface, which is configured such that the module interface, in combination with another module interface (of identical design), can form both a mechanical connection and one or more electrically conductive connections (for energy transmission and/or for data transmission).

The mechanical connection formed by the module interface and the (identically designed) receiving interface can be such that the two interfaces are rigidly connected to one another, essentially with no clearance. The mechanical connection can further be configured such that the connection can accommodate a weight of 10 kg or more, or 20 kg or more.

The expansion module additionally comprises a functional unit, which is designed to provide an expansion function for the onboard electrical system of the vehicle, via the one or more electrically conductive connections. The expansion module thus permits the functional scope of the onboard electrical system to be expanded in an efficient and flexible manner, particularly by increasing the storage capacity of the vehicle and/or permitting flexible charging of the electrical energy store of the vehicle.

The expansion function can comprise e.g. an additional storage capacity for the expansion of the storage capacity of the electrical energy store of the vehicle. The expansion module can thus be employed to increase the electrical energy which is available in the vehicle in an efficient and flexible manner. In particular, this can be achieved wherein additional electrical energy is provided in the vehicle by the replacement of the expansion module in the receiving area.

To this end, the expansion module can comprise a storage module by way of a functional element, which is designed to store electrical energy. The storage module can assume e.g. a storage capacity of 5 kWh or higher. The storage module can comprise a lithium-ion battery.

The expansion module can be configured to transmit electrical energy via the one or more electrically conductive connections between the storage module and the onboard electrical system of the vehicle. In particular, electrical energy can be transmitted from the storage module to the onboard electrical system of the vehicle. The storage capacity of a vehicle can thus be increased in an efficient and flexible manner, e.g. in order to expand the range of the vehicle and/or to provide greater independence from charging stations (particularly in an urban environment).

The expansion module can comprise a DC voltage converter, which is configured to convert electrical energy between a voltage level of the storage module and a voltage level of the onboard electrical system of the vehicle. The DC voltage converter can be arranged e.g. between the storage module and the module interface of the expansion module. In an alternative configuration, the DC voltage converter (optionally with galvanic isolation) can be arranged in the vehicle, e.g. between the receiving interface and the onboard electrical system of the vehicle.

By the provision of an expansion module having a storage module, a particularly flexible expansion of the storage capacity of the vehicle can be permitted.

Alternatively or additionally, the expansion function can comprise an electrically conductive connection of the vehicle to an AC current source or to an AC current sink (in order to permit, by way of an expansion function, charging of the electrical energy store and/or the delivery of electrical energy from the electrical energy store to an off-vehicle AC current sink).

To this end, the expansion module, by way of a functional unit, can comprise an AC current interface. The AC current interface can comprise e.g. a domestic plug socket or a domestic plug.

The expansion module can further comprise an AC/DC (alternating current/direct current) converter or an inverter, which is designed to convert electrical energy between a DC voltage at the module interface and an AC voltage at the AC current interface. The AC/DC converter or inverter can particularly be designed for the take-up or delivery of an AC voltage of 110 V or 230 V at the AC current interface.

The expansion module can thus be configured to charge the electrical energy store of the vehicle with electrical energy from an AC current source. A flexible charging process of the vehicle can thus be permitted. Alternatively or additionally, the expansion module can be designed to supply an AC current sink (e.g. an electrical load) with electrical energy from the electrical energy store of the vehicle. A flexible employment of electrical energy from the electrical energy store of the vehicle can thus be permitted.

The module interface of the expansion module can be configured such that, by means of the module interfaces of two expansion modules, a mechanical and one or more electrically conductive connections can be formed between the two expansion modules. The module interface can thus be symmetrically configured, such that two expansion modules can be mutually connected (in a mechanical and electrically conductive manner) via the respective (identical and/or identically designed) module interface. A particularly flexible employment of expansion modules can be permitted accordingly.

The module interface can comprise a (plane) surface, which is configured to be arranged parallel to the (plane) surface of the identically designed receiving interface, in order to form the mechanical connection and the one or more electrical connections between the expansion module (or module interface) and the receiving area (or receiving interface).

On the surface of the module interface, a first mechanical interface element and a second mechanical interface element can be arranged (which respectively project from the surface). The first mechanical interface element and/or the second mechanical interface element can respectively comprise or form a dovetail guide. Alternatively or additionally, the first mechanical interface element and/or the second mechanical interface element can respectively comprise an undercut. In particular, the first mechanical interface element and the second mechanical interface element can be configured to form, in combination, a positive-locking tongue-and-groove joint.

Alternatively or additionally, the first mechanical interface element and/or the second mechanical interface element can comprise a lead-in region, which permits the respective other mechanical interface element to be pushed onto the respective mechanical interface element. By the provision of an optionally expanded lead-in region, a mechanical connection between the two interfaces can be formed in a particularly convenient manner.

The first mechanical interface element and the second mechanical interface element can further be configured to form a gapless mechanical connection. In particular, the first mechanical interface element and the second mechanical interface element can be configured such that, commencing from the respective lead-in region, any play in the mechanical connection is reduced upon further insertion (optionally, in a continuous manner) until, in the terminal state or terminal position, a gapless mechanical connection is formed.

A secure mechanical connection between the module interface and the identically designed receiving interface can thus be formed in a convenient manner.

The first mechanical interface element and the second mechanical interface element can be configured such that, for the formation of the mechanical connection between the module interface and the identically designed receiving interface, the first mechanical interface element forms a mechanical connection with the second mechanical interface element of the identically designed receiving interface. Moreover, the first mechanical interface element and the second mechanical interface element can be configured such that the second mechanical interface element forms a mechanical connection with the first mechanical interface element of the identically designed receiving interface. By the formation of mechanical connections in pairs, a particularly stable connection can be formed between the module interface and the identically designed receiving interface.

The first mechanical interface element and the second mechanical interface element can be configured such that the mechanical connection and the one or more electrical connections between the expansion module and the receiving area can be formed by the displacement of the parallel-oriented surfaces of the module interface and the identically designed receiving interface in relation to one another. In particular, the interface elements of the module interface and the receiving interface, in the event of parallel-oriented surfaces, can be moved in relation to one another in order to form the mechanical connection and the one or more electrical connections. A particularly convenient employment of an expansion module is permitted accordingly.

On the surface of the module interface, an electrical interface element can be arranged, having one or more electrical contacts (for the corresponding one or more electrically conductive connections). The electrical interface element can be configured, in combination with the electrical interface element of the identically designed receiving interface, to form the one or more electrical connections between the expansion module and the receiving area (particularly by the pushing together of the two electrical interface elements). The one or more electrically conductive connections can thus be formed in a convenient and efficient manner.

The expansion module can comprise a locking mechanism, which is configured to lock the mechanical connection between the module interface and the identically designed receiving interface. A particularly reliable connection can thus be provided.

According to a further aspect, a system is described (e.g. a vehicle or an energy module) which comprises at least one expansion module described in the present document, wherein the expansion module comprises a module interface. The system further comprises a further module (e.g. a further expansion module) having a further interface, which is designed identically to the module interface of the expansion module. The module interface and the further interface are configured to form a mechanical connection and one or more electrically conductive connections between the expansion module and the further module. The further module can comprise e.g. a DC voltage converter and/or an inverter. The expansion module can comprise a storage module. The system can thus be configured in the form of a portable storage unit for the supply of electrical energy (in the form of a DC voltage or an AC voltage).

According to a further aspect, a (road) motor vehicle (particularly a passenger car, a heavy goods vehicle, a bus or a motorcycle) is described. The vehicle comprises an onboard electrical system having an electrical energy store (which is designed e.g. to store electrical energy for the drive system of the vehicle). The vehicle can further comprise the expansion module and/or system described in the present document.

In particular, the vehicle can comprise an (optionally cuboid-shaped) receiving area (e.g. a shaft or slot) for an expansion module. The expansion module can be configured as described in the present document. The receiving area comprises a receiving interface, which is configured, in combination with an identically designed module interface of the expansion module, to form a mechanical connection and one or more electrically conductive connections between the expansion module and the receiving area.

The receiving area can be configured such that, by means of a functional unit of the expansion module which is arranged in the receiving area, via the one or more electrically conductive connections, an expansion function (e.g. an additional storage capacity, a charging function for the charging of the electrical energy store and/or a supply function for the supply of electrical energy) is providable or provided for the onboard electrical system of the vehicle.

It should be observed that the apparatuses and systems described in the present document can be employed, either in isolation or in combination with other apparatuses and systems described in the present document. Moreover, any aspects of the apparatuses and systems described in the present document can be mutually combined in a variety of ways. In particular, the features of the claims can be mutually combined in a variety of ways.

The embodiments of the invention will be described in greater detail hereinafter with reference to exemplary embodiments. In the figures:

### BRIEF DESCRIPTION OF EMBODIMENTS

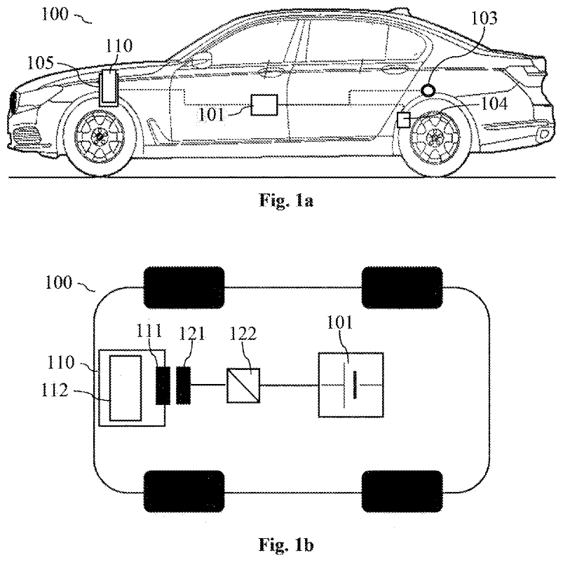

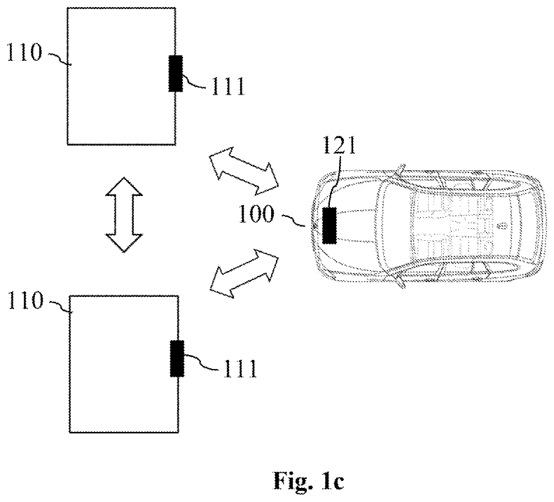

FIGS. 1a and 1b respectively show an exemplary vehicle having an expansion module;

FIG. 1c shows various applications of an expansion module;

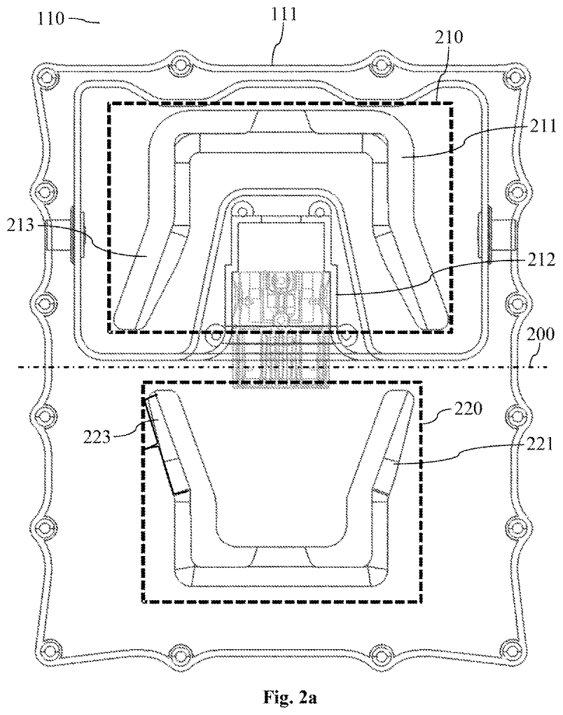

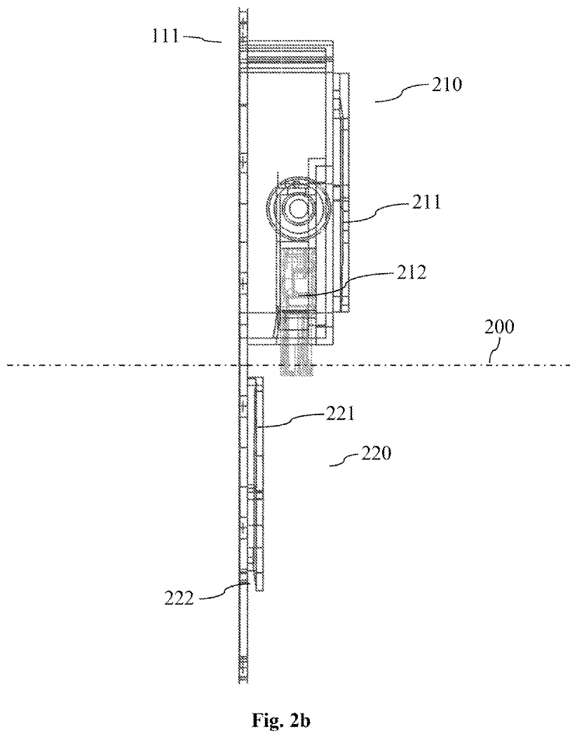

FIGS. 2a and 2b show different views of a module interface of an expansion module;

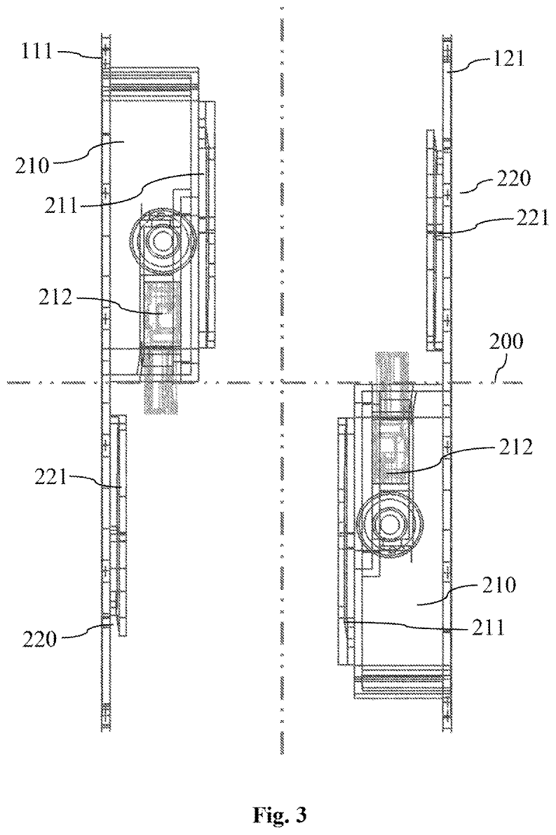

FIG. 3 shows two symmetrical module interfaces for two corresponding expansion modules; and

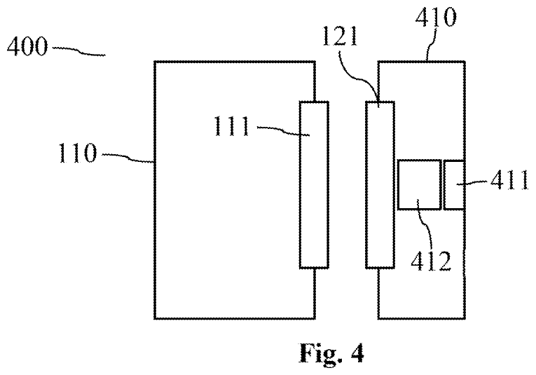

FIG. 4 shows an exemplary energy module having a store expansion module and a converter expansion module.

### DETAILED DESCRIPTION

As indicated above, the present document addresses the flexible charging and/or the flexible expansion of an electrical energy store of a vehicle. In this connection, FIG. 1a shows an exemplary vehicle 100 having an electrical energy store 101, particularly having a high-voltage (h.v.) store, which is designed to store electrical energy for the operation of an electric drive machine 104 of the vehicle 100. The vehicle 100 can comprise a charging interface 103, particularly a charging socket, via which the energy store 101 can be charged by an off-vehicle charging station.

The vehicle 100 can comprise a receiving area 105 for an expansion module 110, wherein the expansion module 110 can be configured for the storage of electrical energy. In particular, the expansion module 110 can comprise an electrical energy store, which can be employed as an auxiliary store in the vehicle 100, in order to increase the quantity of energy available for the drive system of the vehicle 100. The expansion module 110 can thus be configured such that the expansion module 110 can be removed by a user of the vehicle 100 from the receiving area 105, or introduced into the receiving area 105. To this end, at a module interface of the expansion module 110, a low-voltage (l.v.) DC voltage can be delivered (e.g. having a rated voltage of 60 V or lower, particularly having a rated voltage of 48 V or lower).

FIG. 1b shows an exemplary expansion module 110 which comprises an electrical energy store 112 (also described in the present document as a storage module). The expansion module 110 moreover comprises a module interface 111 which, in combination with a complementary (identically designed) interface 121, is configured to form a mechanical and/or an electrical and/or a data interface. As described hereinafter, the interfaces 111, 121 of an associated interface pair can be of an identical and/or a symmetrical design, in order to permit a flexible employment of expansion modules 110.

In the example represented in FIG. 1b, the expansion module 110 is connected via a converter 122, particularly via a DC voltage converter, to the electrical energy store 101 and/or to the onboard electrical system of the vehicle 100, e.g. in order to deliver electrical energy from the expansion module 110 to the onboard electrical system of the vehicle 100 and/or to charge the storage module 112 of the expansion module 110 with electrical energy from the electrical energy store 101 of the vehicle 100.

By the provision of a removable expansion module 110 in a vehicle 100, charging processes can be permitted in a flexible manner. Moreover, the quantity of electrical energy available in a vehicle 100 can be increased in a flexible manner.

As illustrated in FIG. 1c, an expansion module 110 can be employed as an energy source for a vehicle 100. Alternatively or additionally, an expansion module 110 can be employed as an energy sink or as an electrical load which is/are supplied and/or operated with electrical energy from the electrical energy store 101 of the vehicle 100.

FIGS. 2a and 2b show an exemplary module interface 111 for an expansion module 110 and/or for the receiving area 105 of a vehicle 100. FIG. 2a shows an overhead view of the (plane) surface of the module interface 111, which is arranged in parallel with the (plane) surface of the complementary (identically designed) interface 121, in order to form a connection between the two interfaces 111, 121. FIG. 2b shows a side view, laterally to the plane surface of the interface 111, 121.

The interface 111, 121 comprises a first interface part 210 having a first mechanical interface element 211 and an electrical interface element 212. The interface 111, 121 further comprises a second interface part 220 having a second mechanical interface element 221.

In the example represented in FIGS. 2a and 2b, the second mechanical interface element 221 is arranged below a plane of symmetry 200, and the first mechanical interface element 211 is arranged above the plane of symmetry 200. The first mechanical interface element 211 and the second mechanical interface element 221 are configured such that, in combination, the two mechanical interface elements 211, 221 can form a mechanical connection. In particular, the two mechanical interface elements 211, 221 can form a complementary tongue-and-groove guide with an undercut 222 such that, e.g. the second mechanical interface element 221 can be pushed onto the first mechanical interface element 211 (or vice versa).

The electrical interface element 212 can be configured such that two identically designed interface elements 212, which move towards one another from different sides of the plane of symmetry 200 (e.g. from below and above), can form one or more electrically conductive connections and/or data connections.

The module interface 111 can be configured such that, by means of a first interface 111, which moves from the upper side of the plane of symmetry 200 towards the plane of symmetry 200, and by means of an identically designed second interface 121, which moves from the underside of the plane of symmetry 200 towards the plane of symmetry 200, a mechanical connection is formed (between the first mechanical interface element 211 of the first interface 111 and the second mechanical interface element 221 of the second interface 121, and/or between the second mechanical interface element 221 of the first interface 111 and the first mechanical interface element 211 of the second interface 121) and at least one electrically conductive connection is formed (between the electrical interface element 212 of the first interface 111 and the electrical interface element 212 of the second interface 121). This is represented in an exemplary manner in FIG. 3.

The two mechanical interface elements 211, 221 can respectively comprise a lead-in taper 213, 223 (e.g. in the form of a dovetail guide), by means of which a self-centering of the two mechanical interface elements 211, 221 in relation to one another is executed.

The electrical interface element 212 can comprise one or more leading communication contacts for a data connection, by means of which it can be achieved that, in advance of the formation of an (exclusively) electrical connection and/or a mechanical connection, at least one data connection is formed. A reliable connection of different expansion modules 110 and/or of an expansion module 110 with a vehicle receiving area 105 can thus be formed.

For the formation of a connection between a first interface 111 and a second interface 121, the surfaces of both identically designed interfaces 111, 121 can be arranged parallel to each other, such that:
the interface elements 211, 212, 221 of the two interfaces 111, 121 face one another; and
the interface elements 211, 212, 221 of the two interfaces 111, 121 are rotated through 180° in relation to one another.

The first interface 111 and the second interface 121, by the displacement of the mutually parallel-arranged surfaces, can then be moved towards each other, to the effect that:
the first mechanical interface element 211 of the first interface 111 forms a mechanical connection with the second mechanical interface element 221 of the second interface 121;
the second mechanical interface element 221 of the first interface 111 forms a mechanical connection with the first mechanical interface element 211 of the second interface 121; and
the electrical interface element 212 of the first interface 111 forms one or more electrical and/or data connections with the electrical interface element 222 of the second interface 121.

The provision of an interface 111, 121 having a symmetrical design of this type permits a flexible provision and employment of expansion modules 110. In particular, a storage expansion module 110 can be provided which comprises a storage module 112 for the storage of electrical energy and a module interface 111. The storage expansion module 110 can be plugged e.g. into a receiving area 105 of a vehicle 100 (wherein a connection is formed between the module interface 111 of the storage expansion module 110 and the (identically designed) receiving interface 121 of the receiving area 105), e.g. in order to increase the storage capacity of the vehicle 100.

Moreover, a converter expansion module 410 can be provided, as represented in an exemplary manner in FIG. 4. The converter expansion module 410 can comprise a converter 412, e.g. a DC voltage converter, or an AC/DC converter or inverter. In general terms, the converter expansion module 410 can comprise power electronics. The converter expansion module 410 can further comprise a converter interface 411 (particularly an AC current interface), e.g. a domestic plug socket or a domestic plug. The converter expansion module 410 can be configured for the take-up of electrical energy (e.g. on the basis of an AC voltage) at the converter interface 411, the conversion thereof, by means of the converter 412, into DC voltage electricity (at a DC voltage of a specified magnitude) and the delivery thereof via the module interface 121.

The converter expansion module 410 can be associated e.g. with a storage expansion module 110 (via the module interfaces 111, 121) to form an energy module 400, which comprises a storage module 112 which can be charged via a domestic plug socket.

Alternatively or additionally, the converter expansion module 410 can be plugged into the receiving area 105 of the vehicle 100, in order to permit the electrical energy store 101 of the vehicle 100 to be charged via a domestic plug socket.

By means of the universal energy interfaces 111, 121 with a high-voltage vehicle system described in the present document (and which are operable by a vehicle user), an energy load and/or an energy source can be connected to the vehicle 100 in a flexible manner. For example, by means of a storage expansion module 110, an auxiliary electrical energy store 112 for the vehicle 100 can be provided. By the provision of an auxiliary store 112, the dependence of the vehicle 100 upon the charging infrastructure can be reduced.

The module interface 111, 121 described in the present document assumes one or more of the following properties:
the module interface 111, 121 permits bidirectional energy transmission;
the module interface 111, 121 permits the connection of an expansion module 110, 410 (e.g. as a source or a sink);
the module interface 111, 121 permits safe operation of an end user (e.g. at a l.v. voltage level);
the module interface 111, 121 provides full compatibility and assumes an identical design;
the module interface 111, 121 permits a simultaneous mechanical and electrical connection; and/or
the module interface 111, 121 permits an in-vehicle electrical connection to onboard electrical system of the vehicle 100 via an energy converter 122.

The module interface 111, 121 can also be employed for signal transmission. The energy converter 122 can be configured e.g. in the form of a galvanically isolating DC converter. The energy converter 122 can be designed to adjust the voltage and/or the current in a flexible manner. The direction of the power flux can be adjustable accordingly. The adjustable range can be restricted or dictated by the connected expansion module 110, 410 or by the vehicle system.

An exemplary source expansion module 110 can be configured e.g. as a portable energy store. A sink expansion module 410 can be configured e.g. as an inverter 412 for the connection of AC terminal devices (“vehicle to device” connection).

An expansion module 110, 410 can be configured such that it functions as a source or a sink. An inverter expansion module 410, connected to a vehicle 100, can be employed as an external AC charging device. The expansion modules 110, 410 can be respectively configured with a portable design. By means of a locking mechanism between two expansion modules 110, 410, or between an expansion module 110, 410 and the receiving area 105, electrical disconnection under on-load conditions can be prevented in a reliable manner. The locking mechanism can assume further functions, e.g. as a carrier handle.

The electrical coupling of the power transmission path to the high-voltage onboard system of the vehicle 100 can be executed by means of a power electronics converter 122. This can be e.g. a DC voltage converter. The converter 122 can be configured such that a galvanic isolation level vis-à-vis the high-voltage onboard system is provided. The module interface 111, 121 can be configured for a low-voltage (l.v.) rating (e.g. for a rated voltage of 48 V).

The mechanical coupling point 211, 221 between two identically designed interfaces 111, 121 can be configured in the form of a positive-locking tongue-and-groove connection with a circumferential undercut 222. The module interface 111, 121, having a geometrically defined terminal position and location, can secure e.g. an expansion module 110, 410 in a receiving area 105 of a vehicle 100. The structural taper of the mechanical coupling point 211, 221 ensures a gapless arrangement, in the plugged-in state of an interface pair. A structurally dictated (mirror) symmetry permits the full mutual compatibility of the modules 110, 410, 105.

In order to enhance robustness in response to environmental influences and inadvertent maloperation, the coupling point 211, 221 is preferably configured with a planar design. The connecting partner elements (i.e. the complementary mechanical interface elements 211, 221) can be configured as self-locating, by means of a structurally dictated lead-in tolerance. Any relative movement in the x-y axis (i.e. within the respective plane surface) can thus be prevented. This mechanical connection is employed, firstly for geographically defined positioning, and secondly for the accommodation of forces and torques generated in-service. Accordingly, any translational or rotational movement of a bonded interface pair are effectively prevented.

By means of a locking mechanism between two modules 110, 410, 105, electrical disconnection under on-load conditions can be prevented. By way of further functions, the locking mechanism can assume e.g. the function of a carrier handle. The transport of an expansion module 110, 410 can be facilitated by a roller frame. The roller frame can be connected to the expansion module 110, 410 via an interface 111, 121.

Depending upon the respective expansion module 110, 410, 105 employed, e.g. the following scenarios for use are possible:
a portable energy store 112 for the expansion of the storage capacity of a vehicle 100;
infrastructure-independent charging by means of a storage expansion module 110 and/or by means of a converter expansion module 410;
an electrical energy store 112 for decentralized energy supply;
a breakdown assistance facility for a discharged electric vehicle 100;
a portable AC energy supply sourced from the electrical energy store 101 of a vehicle 100; and/or
AC charging of the electrical energy store 101 of a vehicle 100.

By means of the measures described in the present document, flexible charging and/or a flexible expansion of an electrical energy store 101 of a vehicle 100 can be permitted.

The present invention is not restricted to the exemplary embodiments represented. In particular, it should be observed that the description and the figures are only intended to illustrate the principle of the proposed apparatuses and systems in an exemplary manner.

1.-14. (canceled)

15. An expansion module for a vehicle comprising:
an onboard electrical system having an electrical energy store and a receiving area for the expansion module, wherein the expansion module comprises:
a module interface, which is configured to form a mechanical connection to a receiving interface of identical design of the receiving area and one or more electrically conductive collections between the expansion module and the receiving area; and
a functional unit, which is configured to provide an expansion function for the onboard electrical system of the vehicle, via the one or more electrically conductive connections.

16. The expansion module according to claim 15, wherein:
the expansion function comprises an auxiliary storage capacity configured to increase the storage capacity of the electrical energy store of the vehicle; and/or
the expansion module, by way of a functional unit, comprises a storage module which is designed to store electrical energy; and
the expansion module is configured to transmit electrical energy via the one or more electrically conductive connections between the storage module and the onboard electrical system of the vehicle.

17. The expansion module according to claim 16, wherein:
the expansion function comprises an electrically conductive connection of the electrical energy store of the vehicle to an AC current source or to an AC current sink; and/or
the expansion module, by way of a functional unit, comprises an AC current interface; and
the expansion module comprises an AC/DC converter, which is configured to convert electrical energy between a DC voltage at the module interface and an AC voltage at the AC current interface.

18. The expansion module according to claim 17, wherein:
the AC current interface comprises a domestic plug socket or a domestic plug; and/or
the AC/DC converter is designed for the take-up or delivery of an AC voltage of 110 V or 230 V at the AC current interface.

19. The expansion module according to claim 18, wherein the expansion module is configured:
to charge the electrical energy store of the vehicle with electrical energy from an AC current source; and/or
to supply an AC current sink with electrical energy from the electrical energy store of the vehicle.

20. The expansion module according to claim 19, wherein the module interface comprises a plane surface, which is configured to be arranged parallel to the plane surface of the identically designed receiving interface, in order to form the mechanical connection and the one or more electrical connections between the expansion module and the receiving area.

21. The expansion module according to claim 20, wherein:
on the surface of the module interface, a first mechanical interface element and a second mechanical interface element are arranged;
the first mechanical interface element and the second mechanical interface element are configured such that, for the formation of the mechanical connection between the module interface and the identically designed receiving interface:
the first mechanical interface element forms a mechanical connection with the second mechanical interface element of the identically designed receiving interface; and
the second mechanical interface element forms a mechanical connection with the first mechanical interface element of the identically designed receiving interface.

22. The expansion module according to claim 21, wherein:
the first mechanical interface element and the second mechanical interface element respectively comprise a dovetail guide or are configured in the form of a dovetail guide; and/or
the first mechanical interface element and/or the second mechanical interface element respectively comprise an undercut; and/or
the first mechanical interface element and the second mechanical interface element are configured, in combination, to form a positive-locking tongue-and-groove joint; and/or
the first mechanical interface element and/or the second mechanical interface element comprise a lead-in region, which permits the respective other mechanical interface element to be pushed onto the respective mechanical interface element; and/or
the first mechanical interface element and the second mechanical interface element are configured to form a gapless mechanical connection.

23. The expansion module according to claim 22, wherein the first mechanical interface element and the second mechanical interface element are configured such that the mechanical connection and the one or more electrical connections between the expansion module and the receiving area can be formed by the displacement of the parallel-oriented surfaces of the module interface and the identically designed receiving interface in relation to one another.

24. The expansion module according to claim 23, wherein:
an electrical interface element having one or more electrical contacts is arranged on the surface of the module interface; and
the electrical interface element is configured, in combination with the electrical interface element of the identically designed receiving interface, to form the one or more electrical connections between the expansion module and the receiving area.

25. The expansion module according to claim 24, wherein the module interface is configured such that, by means of the module interfaces of two expansion modules, a mechanical and one or more electrically conductive connections can be formed between the two expansion modules.

26. The expansion module according to claim 25, wherein the expansion module comprises a locking mechanism, which is configured to lock the mechanical connection between the module interface and the identically designed receiving interface.

27. A system, comprising:
an expansion module according to claim 26; wherein the expansion module comprises a module interface; and
a further module having a further interface, which is designed identically to the module interface of the expansion module; wherein the module interface and the further interface are configured to form a mechanical connection and one or more electrically conductive connections between the expansion module and the further module.

28. A vehicle comprising:
an onboard electrical system having an electrical energy store; and
a receiving area for an expansion module; wherein the receiving area comprises a receiving interface which is configured, in combination with an identically designed module interface of the expansion module to form a mechanical connection and one or more electrically conductive connections between the expansion module and the receiving area;
wherein the receiving area is configured such that, by means of a functional unit of an expansion module which is arranged in the receiving area, via the one or more electrically conductive connections, an expansion function is providable for the onboard electrical system of the vehicle.
